(19) United States
(12) Patent Application Publication
(10) Pub. No.: US 2026/0042374 A1
(43) Pub. Date: Feb. 12, 2026

(54) A CONTROLLER

(71) Applicant: 3ti Energy Hubs Ltd, Surrey (GB)

(72) Inventor: Mark Potter, Surrey (GB)

(21) Appl. No.: 19/100,826

(22) PCT Filed: Jul. 17, 2023
(86) PCT No.: PCT/EP2023/069775

§ 371 Date: Feb. 3, 2025

(30) Foreign Application Priority Data
Aug. 2, 2022 (GB) 2211228.8

(51) Int. Cl. B60L 53/67; B60L 53/16; B60L 53/62; H02J 7/04

(52) U.S. Cl. CPC B60L 53/67; B60L 53/16; B60L 53/62; H02J 7/04

(57) ABSTRACT

A method for an electric vehicle (EV) charging system having a first EV charging port and a second EV charging port in which a first EV attached to the first EV charging port has a single phase charging system and a second EV attached to the second EV charging port has a multi-phase charging system, the method comprising determining a first charge current limit to be applied by the first charge port to the single phase charging system of the first EV and a second charge current limit to be applied by the second charge port to each phase of the multi-phase charge system of the second EV to allow the first EV to be charged with a first power value and the second EV to be charged with a second power value, wherein the first power value and the second power value have a predetermined relationship.

### BACKGROUND

The present invention relates to a controller, in particular a controller for an electric vehicle, EV, charging system having a first EV charging port and a second EV charging port.

Most modern EVs support AC charging using an on-board charger, which will take variously single-phase power (typically 3.6-7 kW) or three-phase power (typically 11-22 kW) depending on the EV manufacturer's design specifications. In order to provide support for both three-phase and single-phase EV charging, AC EV charging infrastructure needs to be supplied as three phase.

To minimise EV charging infrastructure cost, dynamic load management, DLM, systems are used for systems with multiple charge points. DLM systems will use signalling between an EV charge point and an EV to avoid exceeding maximum supply capability, for example by reducing charge current to an EV.

To reduce charge current to an EV, DLM systems operate by limiting phase current signalling to the vehicle, based on feedback from current transducers measuring the charge point or system load. However, typically a DLM system's ability to identify the charging capability of a vehicle is limited.

Consequently, for a given phase current, a single phase and a three phase vehicle may receive different total power, resulting in a non-equitable distribution of energy.

It is desirable to improve this situation.

In accordance with an aspect of the present invention there is provided a controller and method according to the accompanying claims.

The present invention provides a controller for detecting the configuration of an EV coupled to an EV charging system and enabling equitable charging power control of the EV based on the configuration. Additionally, equitable charging power control of the EV may also be determined based on a charging power allocation for the vehicle, which may be determined by one or several factors, including user selection, power-based (or charge time-based) tariffs, system power constraints (for example, available system power or storage battery state of charge), regulatory limitations (for example, time of day constraints), and availability of other power sources such as Vehicle-to-Grid, Solar Photovoltaic.

Preferably, a determination is made as to whether a vehicle supports a single phase or three phase charging system by applying a predetermined current limit, typically the lowest current supported by the standard, and measuring how many phases the EV draws power from, and subsequently increases the current limit to achieve a power allocation for the vehicle.

The present invention will now be described, by way of example, with reference to the accompanying drawings in which:

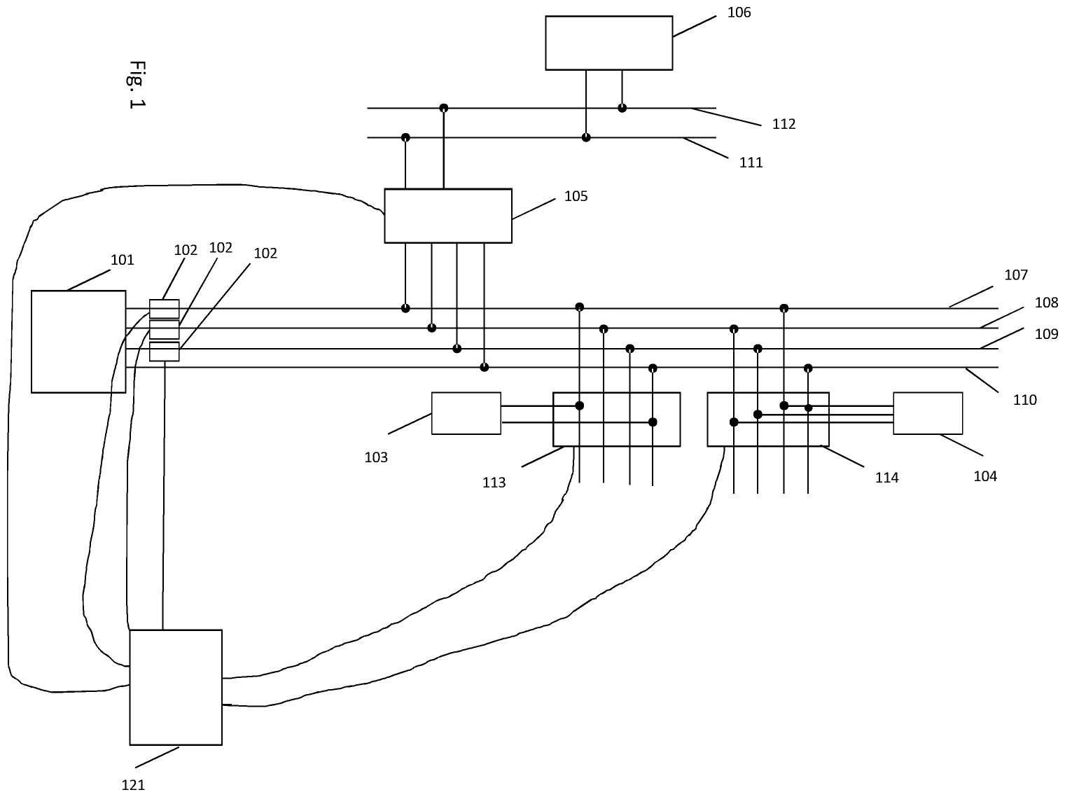

FIG. 1 illustrates a schematic of an electric vehicle charging system in accordance with an aspect of the present invention.

In accordance with an embodiment of the present invention, FIG. 1 illustrates a three phase mains supply 101, otherwise known as a grid supply, to which is coupled a three phase electrical bus, which include three electrical buses 107, 108, 109 and a neutral 110, however any multi-phase supply may be used.

Coupled to each of the three electrical buses 107, 108, 109 is a respective current sensor 102, for example a current transformer, which are coupled to a controller 121, where the controller is arranged to monitor the current on each of the electrical busses 107, 108, 109 using the current sensor 102 readings.

The three phase electrical bus is coupled to a DC bus 111, 112 via an AC/DC converter 105 that can act as an inverter and/or rectifier.

Also coupled to the DC bus 111, 112 is a photovoltaic, PV, panel 106 that is arranged to generate an electrical current when exposed to sunlight. Typically the PV panel will be connected to the DC bus via power control electronics, for example a maximum power point tracker, a DC:DC converter or a pulse width modulation, PWM, controller. Preferably, a DC battery (not shown) is also coupled to the DC bus 111, 112 for storing charge from the three phase mains supply and/or the PV panel 106. The battery may be directly or indirectly connected to the DC bus. If the battery is indirectly connected to the DC bus typically this will be via power control electronics. The PV panel 106 will typically comprise an array of PV panels, as such any reference to PV panel includes an array of PV panels or any other PV panel configuration, for example where one or more maximum power point tracking controllers are coupled to one or more PV arrays.

Additionally, a first electric vehicle, EV, charging port 113 and a second electric vehicle, EV, charging port 114 are coupled to the three phase electrical bus 107, 108, 109, 110 to support single phase AC charging or three phase AC charging for an EV. For the purposes of the present embodiment, a first EV 103, having a single phase on-board charging system, is coupled to the first EV charging port 113 and a second EV 104, having a three phase on-board charging system, is coupled to the second EV charging port 114. Although the present embodiment describes the EV charging system as having two EV charging ports connected to the electrical bus 107, 108, 109, 110, any number of EV charging ports may be connected.

Preferably the first EV charge port 113 and second EV charge port 114 will act as controlled loads, where the controller 121 can dynamically vary the load that each EV charging port imparts on the electrical system. For example, if an EV charging port is being used to charge an EV that is causing a load imbalance between the different electrical busses 107, 108, 109, the controller 121 can dynamically vary the power provided by the EV charging port to reduce the load imbalance. As such, the controller 121 can control current from an EV, charging port to an EV if the current difference between the first electrical bus, the second electrical bus and/or the third electrical bus exceeds a predetermined threshold value to substantially balance the current load on the first electrical bus, the second electrical bus and the third electrical bus.

Based on predetermined criteria the controller 121 is arranged to independently control current limits for each EV charging port 113, 114 to allow equitable charging power control for EVs connected to the EV charging ports 113, 114. As such, a first charge current limit is determined for the first EV charging port 113 and a second charge current limit is determined for each phase of the second EV charge port 114 to allow the first EV to be charged with a first power value and the second EV to be charged with a second power value, wherein the first power value and the second power value have a predetermined relationship.

Although the current limit set by the controller 121 indicates the maximum current that an EV charging port is capable of delivering, the actual current supplied to a vehicle may be less depending on other criteria. For example, if a battery for an EV is fully charged, no current will be drawn by the charging system for the EV, irrespective of the current limit that may have been set. However, for the purposes of the present embodiment, it is assumed that the current provided by the EV charging ports 113, 114 will correspond to the respective current limits set for each EV charging port 113, 114.

Examples of criteria used for independently controlling current limits include 1) User Selection, 2) Power Based Tariffs, 3) Charge Time Based Tariffs, 4) System Power Constraints, and 5) Regulatory Limitations.

By way of illustration, for user selection or power based tariffs, if the owner of the second EV 104 selects an 5 kW charge rate, as the second EV 104 has a three phase on-board charging system the controller 121 is arranged to set a 7.2 Amp current limit on each phase of the second EV charging port 114, assuming the EV charging system uses a 230 volt system line voltage. In contrast, if the owner of the first EV 103 also selects a power value having a 5 kW charge rate limit, as the first EV 103 has a single phase on-board charging system, the controller 121 is arranged to set a 21.7 Amp current limit for the first EV charging port 113, thereby allowing independent current limits to provide the required power values for both the first EV 103 and the second EV 104. Without independent current limits being set for each three phase capable EV charging port, if a 7.2 Amp current limit were to be applied to both the first EV charging port 113 and the second EV charging port 114, while the second EV 104 would have a 5 kW charge rate as a result of received current on three phases, the first EV charging port 113 would only deliver a 1.7 kW charge rate for the first EV 103. This is the status quo for established current based control systems, which do not alter charge current based on vehicle phase power use.

In another scenario, a system power constraint may exist, where the controller 121 makes a determination that the EV charging system has insufficient power to support a requested charge rate for both the first EV 103 and the second EV 104 (i.e. a power limit condition exists). In this scenario, the controller 121 selects different current limits for the first EV charging port 113 and the second EV charging port 114 to provide equitable distribution of power between the first EV 103 and the second EV 104, where the combination of the power value allocated to the first EV 103 and the power value allocated to the second EV 104 is equal or less than the power available to be allocated by the EV charging system.

In determining an equitable distribution of power between the first EV 103 and the second EV 104, the controller 121 is preferably arranged to determine a maximum power limit for the single phase charging system of the first EV and a maximum power limit for the three-phase charging system of the second EV, thereby ensuring that a current limit allocated to a charging port does not exceed the power rating for an EV.

For example, if the EV charging system has a 12 kW system power limit and the owner of the first EV 103 selects a 7 kW charge rate and the owner of the second EV 104 selects an 11 kW charge rate, the combined charge rate for the first EV 103 and the second EV 104 will exceed the EV charging system's 12 kW system power limit. In this scenario, the controller 121 makes a determination as to how much power to allocate to each EV based on predetermined criteria, for example to split the available power equally between the first EV and the second EV or to pro rata the power between the first EV and the second EV based on the charge rate selected for the respective EVs. However, any criteria may be used for allocating power between the first EV 103 and second EV 104, where the power allocated to the first EV 103 and power allocated to the second EV 104 have a predetermined relationship.

Based on the above example, if the controller 121 determines that substantially equal power is to be allocated to both the first EV 103 and the second EV 104, the controller 121 calculates a 26 Amp current limit for the first charging port 113 for charging the first EV 103 over a single phase, thereby providing a charge rate of 5980 W to the first EV 103, and an 8.5 Amp current limit for the second charging port 114 for charging the second EV 104 over each of the three phases, thereby providing a charge rate of 5865 W to the second EV 104, thus the combined charge rate to the first EV 103 and the second EV 104 is less than the system power limit.

Preferably the controller 121 includes means for determining whether an EV connected to an EV charging port includes a single phase charging system or a multi-phase charging system, for example a three phase charging system. For example, by applying a predetermined current limit to the charging system of an EV and measuring individual phase currents provided to the EV, such that if an EV has a single phase on-board charging system current will only flow on a single phase, while if an EV has a three phase on-board charging system current will flow over all three phases.

Although the above embodiments describe a static configuration, with the first EV 103 being connected to the first EV charging port 113 and the second EV 104 being connected to the second EV charging port 114, the controller 121 can be arranged to dynamically adjust current limits based on changing conditions. For example, in a scenario where the EV charging system has a system power constraint and a third EV (not shown), having either a single phase or three phase on-board charging system, is connected to a third EV charging port (not shown), the controller is arranged to determine current limits for the first EV charging port, the second EV charging port and the third EV charging port that would ensure the power limit for the EV charging system is not exceeded while providing equitable distribution of power between the first EV, the second EV and the third EV. Similarly, if one of the EVs were to be disconnected or stop drawing power from the EV charging system, the controller is arranged to recalculate respective current limits for EVs still connected to the EV charging system.

To aid load balancing between the different phases of the electrical buses 107, 108, 109, preferably the controller 121 is arranged to monitor the current load on each of the electrical buses 107, 108, 109, wherein the controller 121 is arranged to control the AC/DC converter 105, acting as an inverter, to provide current generated by the PV panel 106 on to one or more of the electrical busses 107, 108, 109 if the current difference between the electrical busses 107, 108, 109 exceeds a predetermined threshold, thereby allowing the current loads on each of the electrical busses 107, 108, 109 to be balanced. The predetermined threshold may be selected based on the electrical bus/load configuration and the electrical losses that may be acceptable resulting from a load imbalance between the electrical busses 107, 108, 109. However, preferably the current difference between the electrical busses 107, 108, 109 will be substantially zero.

For example, if one or more of the charge ports is being used to provide a single phase charge to an EV, which causes a phase imbalance between the electrical busses 107, 108, 109, in addition to or alternatively to controlling the current load of the one or more charge ports, the current generated by the PV panel 106 can be used to balance the current loads between the electrical busses 107, 108, 109 by directing current from the PV panel 106 to one or more of the electrical busses 107, 108, 109. This can also provide the advantage of allowing an EV to be charged using less power from the three phase mains supply 101 than otherwise would be used.

Preferably, to supplement current generated by the PV panel 106, the controller can be arranged to provide current from the battery, via the AC/DC converter operating as an inverter, on to one or more of the electrical busses 107, 108, 109. For example, if the controller 121 has identified a current/phase imbalance on the electrical bus and the current generated by the PV panel 106 is not sufficient to fully balance a current imbalance on the electrical bus, for example during bad weather when little power is generated by the PV panel 106 or at night time when no power is generated by the PV panel 106, the controller can direct current from the battery to one or more of the electrical busses 107, 108, 109 to supplement the current generated by the PV panel 106 to allow the current loads on each of the electrical busses 107, 108, 109 to be balanced.

Additionally, the controller 121 may be configured to control the AC/DC converter 105 to balance the current load on the electrical bus by providing current from one or more of the electrical busses 107, 108, 109 to another one or more of the electrical busses 107, 108, 109, if the current difference between any one of the electrical busses 107, 108, 109 exceeds a predetermined threshold value to substantially balance the current load on the electrical bus. For example, the controller 121 may be configured to balance the current load by transferring current from one electrical bus to another electrical bus if the current generated by the PV panel 106 is not sufficient to fully balance a current imbalance on the electrical bus

Consequently, the controller can reduce a phase/load imbalance between the electrical buses 107, 108, 109 by controlling a controller load coupled to the electrical bus, by directing current from the PV panel 106 to one or more electrical buses, by directing current from the battery to one or more electrical buses and/or diverting current from one electrical bus to another electrical bus.

1. A method for an electric vehicle, EV, charging system having a first EV charging port and a second EV charging port in which a first EV attached to the first EV charging port has a single phase charging system and a second EV attached to the second EV charging port has a multi-phase charging system, the method comprising determining a first charge current limit to be applied by the first charge port to the single phase charging system of the first EV and a second charge current limit to be applied by the second charge port to each phase of the multi-phase charge system of the second EV to allow the first EV to be charged with a first power value and the second EV to be charged with a second power value, wherein the first power value and the second power value have a predetermined relationship.

2. A method according to claim 1, wherein the first power value and the second power value are arranged to be substantially the same.

3. A method according to claim 1, further comprising determining that the first EV has a single phase charging system.

4. A method according to claim 3, wherein determining that the first EV has a single phase charging system comprises applying a predetermined current limit to the charging system of the first EV and measuring individual phase currents provided to the first EV.

5. A method according to claim 1, further comprising determining that the second EV has a multi-phase charging system.

6. A method according to claim 5, wherein determining that the second EV has a multi phase charging system comprises applying a predetermined current limit to the charging system of the second EV and measuring individual phase currents provided to the second EV.

7. A method according to claim 1, wherein the multi-phase charging system is a three phase charging system.

8. A method according to claim 1, further comprising determining a power limit for the EV charging system and arranging that the combination of the first power value and the second power value is less than the power limit.

9. A method according to claim 8, further comprising determining a maximum power limit for the single phase charging system of the first EV and a maximum power limit for the multi-phase charging system of the second EV.

10. A method according to claim 9, further comprising determining that the power limit for the EV charging system is less than the combined maximum power limit for the single phase charging system of the first EV and the multi-phase charging system for the second EV.

11. A controller for an electric vehicle, EV, charging system having a first EV charging port and a second EV charging port in which a first EV attached to the first EV charging port has a single phase charging system and a second EV attached to the second EV charging port has a multi-phase charging system, the controller comprising a device arranged to determine a first charge current limit to be applied by the first charge port to the single phase charging system of the first EV and a second charge current limit to be applied by the second charge port to each phase of the multi-phase charge system of the second EV to allow the first EV to be charged with a first power value and the second EV to be charged with a second power value, wherein the first power value and the second power value have a predetermined relationship.

12. A controller according to claim 11, wherein the first power value and the second power value are arranged to be substantially the same.

13. A controller according to claim 11, wherein the device is arranged to determine that the first EV has a single phase charging system.

14. A controller according to claim 13, wherein the device is arranged to determine that the first EV has a single phase charging system by applying a predetermined current to the charging system of the first EV and measuring individual phase currents provided to the first EV.

15. A controller according to claim 11, wherein the device is arranged to determine that the second EV has a multi-phase charging system.

16. A controller according to claim 15, wherein the device is arranged to determine that the second EV has a multi phase charging system by applying a predetermined current to the charging system of the second EV and measuring individual phase currents provided to the second EV.

17. A controller according to claim 11, wherein the multi-phase charging system is a three phase charging system.

18. A method according to claim 11, wherein the device is arranged to determine a power limit for the EV charging system and arranging that the combination of the first power value and the second power value is less than the power limit.

19. A method according to claim 18, wherein the device is arranged to determine a maximum power limit for the single phase charging system of the first EV and a maximum power limit for the multi-phase charging system of the second EV.

20. A method according to claim 19, wherein the device is arranged to determine that the power limit for the EV charging system is less than the combined maximum power limit for the single phase charging system of the first EV and the multi-phase charging system for the second EV.
